(19) United States
(12) Patent Application Publication
(10) Pub. No.: US 2012/0206047 A1
(43) Pub. Date: Aug. 16, 2012

(54) CURRENT SENSING TRANSISTOR LADDER DRIVER FOR LIGHT EMITTING DIODES

(75) Inventor: Martin J. Vos, Minneapolis, MN (US)

(73) Assignee: 3M Innovative Properties Company

(21) Appl. No.: 13/024,825

(22) Filed: Feb. 10, 2011

(51) Int. Cl. H05B 37/02

(52) U.S. Cl. 315/122

(57) ABSTRACT

Ladder network circuits for controlling operation of light emitting diodes (LEDS) based upon current sensing. The circuits include a number of light sections connected in series. Each light section includes an LED device comprising at least one LED junction, a current sensing feedback circuit coupled to the LED device, and a switch coupled to the current sensing feedback circuit and the LED device for controlling activation and current through the LED device. The current sensing feedback circuit is configured to generate a sensing signal indicative of current through the LED device, generate a feedback signal based upon the sensing signal, and provide the feedback signal to the switch.

### BACKGROUND

Light emitting diodes (LEDs) typically have low forward drive voltages and can be driven by a DC power supply. For example, LEDs in a cellular phone are powered by a battery. A string of multiple LEDs in series can also be directly AC driven from a standard AC line power source. For example, Christmas tree LED lights are a string of LEDs connected in series so that the forward voltage on each LED falls within an acceptable voltage range. Alternatively, a string of LEDs can be driven by a DC power source, which requires conversion electronics to convert a standard AC power source into DC current.

### SUMMARY

A first circuit for controlling operation of a plurality of light emitting diodes (LEDs), consistent with the present invention, includes a plurality of light sections connected in series and configured for connection to an AC power source. Each light section comprises an LED having an LED current flowing through the LED, a switch coupled to the LED, and a current sensing feedback circuit coupled to the switch and the LED. The current sensing feedback circuit is configured to generate a sensing signal indicative of the LED current, generate a feedback signal based upon the sensing signal, and provide the feedback signal to the switch. The switch activates the LED and controls the LED current based upon the feedback signal. At least two light sections are activated in sequence in response to power supplied from the AC power source.

A second circuit for controlling operation of light emitting diodes (LEDs), consistent with the present invention, also includes a plurality of light sections connected in series and configured for connection to a power source. Each light section includes an LED device comprising at least one LED junction, a current sensing element coupled to the LED device, an amplification circuit having fixed value components coupled to the current sensing element, and a switch coupled to the amplification circuit and the LED device. An LED current flows through the LED device. The current sensing element is configured to generate a signal indicative of the LED current. The amplification circuit is configured to receive the signal indicative of the LED current and to output a signal based upon the received signal. The switch activates the LED device and controls the LED current based upon the output signal of the amplification circuit. At least two light sections are activated in sequence in response to power output from the power source.

### BRIEF DESCRIPTION OF THE DRAWINGS

The accompanying drawings are incorporated in and constitute a part of this specification and, together with the description, explain the advantages and principles of the invention. In the drawings,

FIG. 1 is a block diagram of a current-sensing LED ladder driver circuit;

FIG. 2 is an exemplary circuit block diagram of a current-sensing LED ladder driver circuit;

FIG. 3 is an exemplary diagram of a current-sensing LED ladder driver circuit for one LED device;

FIG. 4 is a graph illustrating voltage-current characteristics for two types of LEDs;

FIG. 5 is a graph illustrating power factor performance of the current-sensing LED ladder driver in FIG. 3; and

FIG. 6 is a graph illustrating a current spectrum of a current-sensing LED ladder driver having harmonic distortion within the IEC Limits.

### DETAILED DESCRIPTION

A plurality of light emitting diodes (LEDs) in series can be directly AC driven from a standard AC line power source. A directly AC driven LEDs in series, however, often exhibits significant harmonic distortion, which is undesirable. Also, the dimming capability is compromised. Therefore, a modification or improvement is desirable to allow a sufficient current flow for low drive voltages with minimum harmonic distortion and near unity power factor resulting in an implementation allowing dimming capability, particularly as LED lights replace incandescent and fluorescent lamps.

The present disclosure is directed to embodiments of LED driver circuits allowing driving multiple LEDs in series in AC line applications with minimal harmonic distortion in drive current and near unity power factor. The driver circuits are designed to be converted to integrated circuits (ICs) such that the costs of the circuits are reduced for large quantity manufacturing. In some embodiments, the driver circuits do not have inductor elements that are not feasible components to be fabricated onto an IC chip. In some other embodiments, the driving circuits comprise only fixed value components, such as fixed value resistors or capacitors, which reduces the manufacturing complexity and cost. The circuits also allow direct dimming as well as color variation with a dimmer circuit, for example, a conventional TRIAC dimmer. Furthermore, the circuitry has line voltage surge protection capability and a relative insensitivity to undervoltage operation.

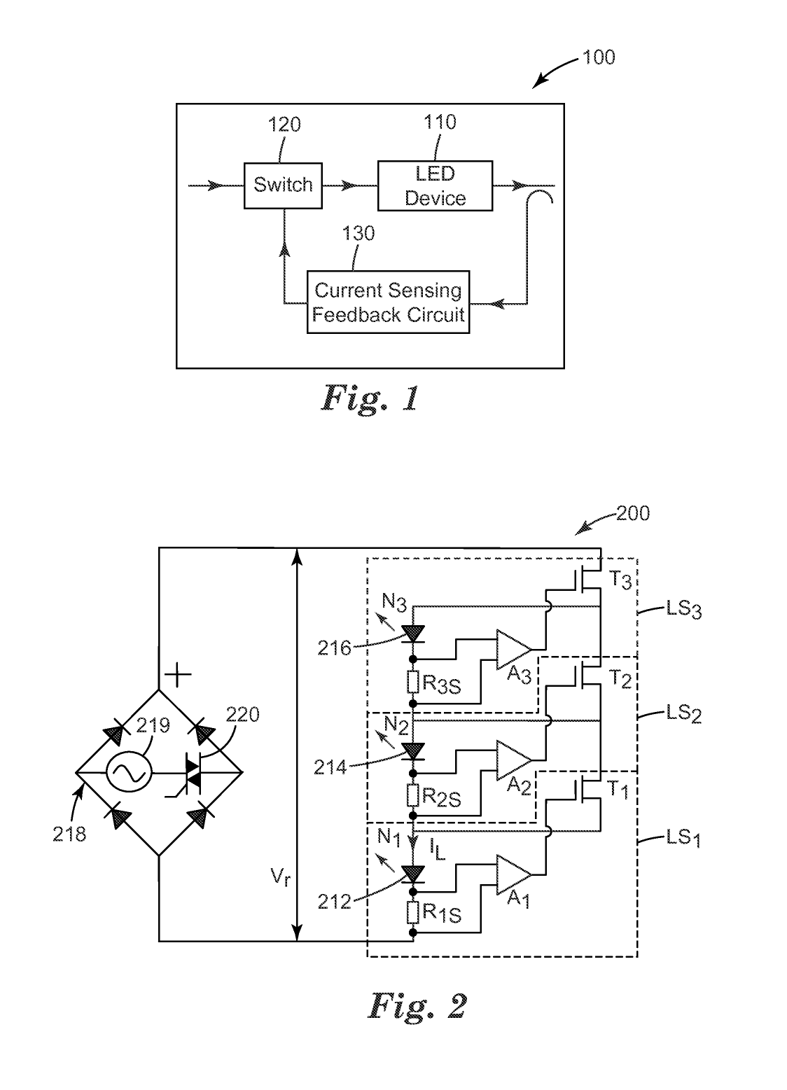

FIG. 1 is a block diagram of an exemplary current sensing LED driver circuit 100 for a light section. In some embodiments, a plurality of light sections are connected in series and configured to connect to a power source, such as an AC power source. The current sensing LED driver circuit 100 includes an LED device 110, a switch 120, and a current sensing feedback circuit 130. The LED device 110, also referred to as a ‘LED’, comprises one or more LED junctions, where each LED junction can be implemented with any type of LED of any color emission but with preferably the same current rating. In some embodiments, the LED junctions are connected in series. Multiple LED junctions can be contained in a single LED housing or among several LED housings. For example, the LED device 110 may comprise six LED junctions within one LED housing. The switch 120 can be implemented by a normally-closed switch, for example, a depletion FET. Normally the switch 120 is closed and an LED current flows through the LED device 110. The current sensing feedback circuit 130 is configured to generate a sensing signal indicative of the LED current, generate a feedback signal based upon the sensing signal, and provide the feedback signal to the switch 120. In some embodiments, the current sensing feedback circuit 130 includes one or more current sensing elements to generate a signal indicative of the LED current. In an exemplary embodiment, the current sensing feedback circuit 130 includes a sensing resistor capable of providing a voltage signal based upon the LED current. In some embodiments, the current sensing feedback circuit 130 includes one or more active components, for example, a transistor or an amplifier, such that the signal indicative of the LED current is amplified as a feedback signal to further control the LED current. The current sensing feedback circuit 130 may include an enhancement FET, a bipolar transistor, an amplifier, a comparator, or a combination of those components.

FIG. 2 is an exemplary circuit block diagram of a current sensing transistor ladder driver circuit 200 for driving a plurality of LEDs connected in series. Circuit 200 includes a series of three (m=3) light sections LS₁, LS₂, and LS₃ connected in series. Each light section j(1≦i≦m) controls Nⱼ LED junctions. The first section includes N₁ LED junctions 212 depicted as one diode, an amplification circuit A₁, a sensing resistor R₁ₛ, and a transistor T₁ functioning as a switch. The second section includes N₂ LED junctions 214 depicted as one diode, an amplification circuit A₂, a sensing resistor R₂ₛ, and a transistor T₂. The third section includes N₃ LED junctions 216 depicted as one diode, an amplification circuit A₃, a sensing resistor R₃ₛ, and a transistor T₃.

Switch transistors T₁, T₂, and T₃ can each be implemented by a depletion MOSFET, for example a BSP149 transistor. In some embodiments, in each light section, the transistor T is a depletion transistor functioning as a normally-on switch in order to activate or de-activate (turn on or off) the corresponding LED device. In some cases, the depletion transistor is selected with characteristics of a drain-source channel resistance R_{ds} being very low (one ohm or so) for zero gate-source voltage, V_{gs}=0. The transistors form a ladder network in order to activate the LEDs in sequence from the first section (LS₁) to the last section (LS₃) in FIG. 2.

The sensing resistor Rⱼₛ (i.e. j=1, 2, 3 in FIG. 2) is connected in series with an LED in the corresponding section j. The sensing resistor Rⱼₛ represents a resistive element converting the current I_{L} flowing through the LED to a voltage. In a preferred embodiment, the resistor Rⱼₛ can have small resistance value, for example 1 ohm or 0.1 ohm, such that power dissipation in the sensing resistor Rⱼₛ is negligible. The amplification circuit A amplifies the voltage converted from the LED current I_{L} to a meaningful gate-source voltage to control the LED current I_{L} through the transistor T.

The light sections LS₁, LS₂, and LS₃ are connected to a rectifier 218 including an AC power source 219 and a dimmer circuit 220. In FIG. 2, the dimmer circuit 220 is depicted as a TRIAC but can also be based on other line phase cutting electronics. In a practical 120 VAC case there are preferably more than three sections, possibly eight to sixteen sections to bring the section voltage into a range of 10 to 20 volt.

In FIG. 2, only three light sections are shown, but the ladder can be extended to any m light sections with a number of Nⱼ LED junctions for each light section j that is consistent with the maximum Vᵣ drive voltage where the total number of LED junctions is given by the summation of

$${\sum }_{j = 1}^{m} {N}_{j} .$$

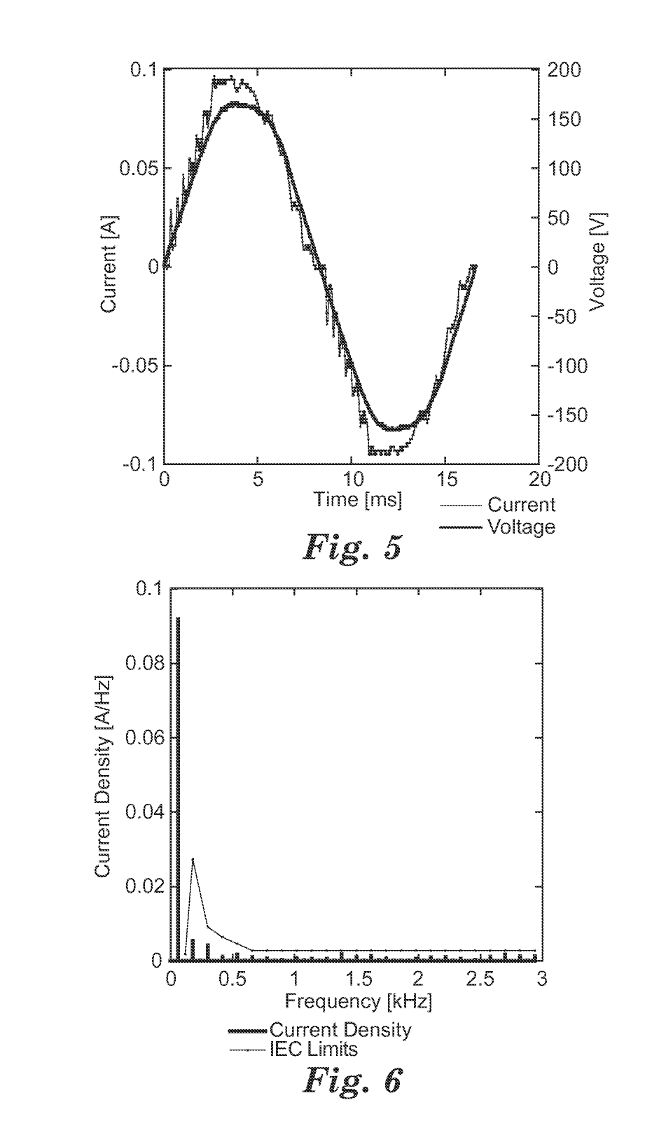

Also, each light section can contain more than one LED junction. In some case, each light section contains at least three LED junctions. Multiple LED junctions can be contained in a single LED component or among several LED components. The transistor T of the last light section (transistor T₃ in FIG. 2) serves as the ultimate line voltage surge protector that limits the LED current. This current limit is visible as the maximum plateau in FIG. 5.

During extreme line power consumption, an undervoltage situation can occur that may lead to one or more upper LED sections not being illuminated. The other sections however remain illuminated at their rated currents so that undervoltage situations have a limited effect on the total light output.

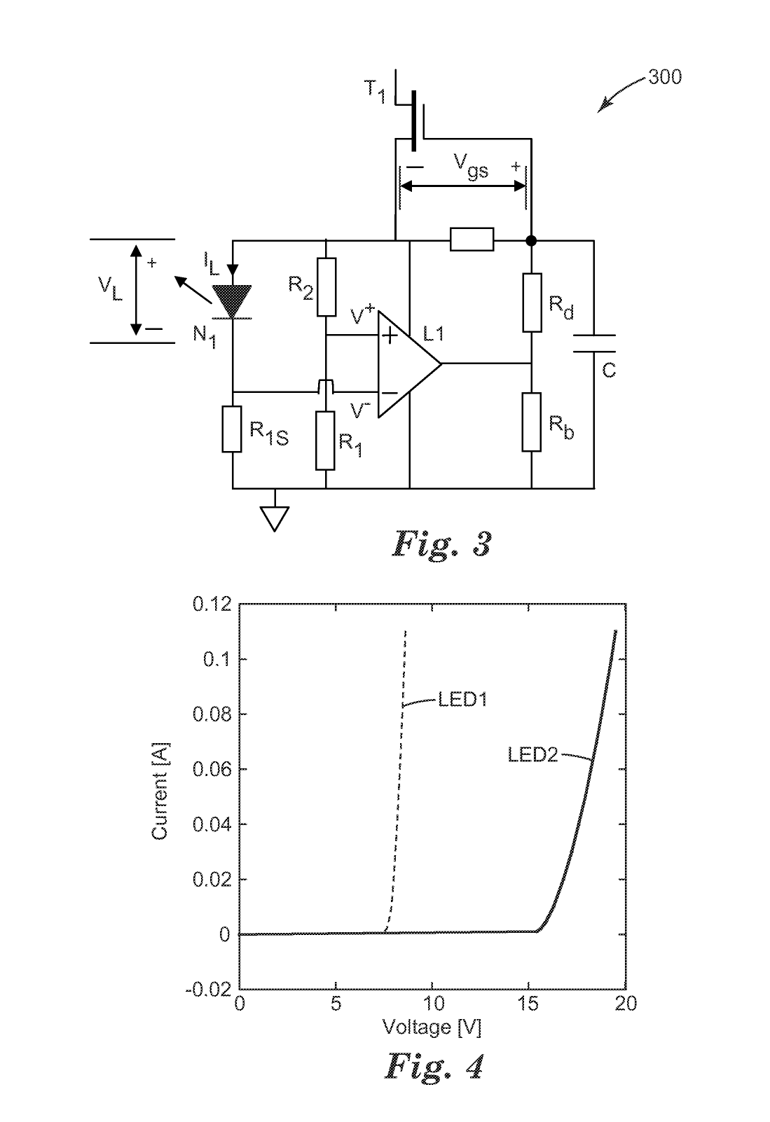

FIG. 3 is an exemplary circuit diagram of a current sensing LED ladder driver circuit 300 for one LED device illustrating details of the amplification circuit A shown in FIG. 2. The circuit 300 includes a sensing resistor R₁ₛ and a switch transistor T₁ that are also included in the circuit 200 as illustrated in FIG. 2. The circuit 300 includes additional resistors R₁, R₂, R_{b}, R_{d}, and R_{gs}, an amplifier L₁, and a capacitor C illustrating an exemplary implementation of an amplification circuit, such as amplification circuit A₁ as shown in FIG. 2.

In a particular embodiment, the amplifier L₁ can be a comparator, for example, a LP339 comparator. In some embodiments, the amplifier L₁ is an amplifier operable with low supply current. The comparator inverting input voltage V⁻ is a voltage converted from the LED current I_{L} by the sensing resistor R₁ₛ. When the LED current I_{L} is small, the comparator inverting input voltage V⁻ is less than the non-inverting input voltage V⁺. As a result, the comparator output is ‘high’ and no current will flow through R_{gs} so that the depletion FET T₁ will allow unrestricted current flow through the LED. However, with the LED current I_{L} increasing during the ascent portion of the applied AC voltage, V⁻ will eventually exceed V⁺ so that the comparator output will turn ‘low’ at which point a controlled LED current I_{L} is enforced through continuous feedback given by:

$${I}_{L} = \frac{{R}_{1} {V}_{L}}{{R}_{2} {R}_{1 s}} \qquad ( 1 )$$

The gate-source voltage is always negative and will swing roughly between:

$$- \frac{{V}_{L} {R}_{gs}}{{R}_{d} + {R}_{gs}} < {V}_{gs} < - \frac{{V}_{L} {R}_{gs}}{{R}_{b} + {R}_{d} + {R}_{gs}} \qquad ( 2 )$$

During the ascent portion of the applied AC voltage, an upper LED section will push a higher LED current I_{L} through a lower section, the gate-source voltage V_{gs} of the lower section becomes more negative and its drain-source resistance R_{ds} increases. Accordingly, the lower section switch transistor T becomes more pinched off and the drain-source current I_{ds} becomes negligible (i.e. close to 0). When the applied AC voltage becomes higher, switch transistors of more lower LED sections have negligible drain-source current. As a result, the lower LED sections have high efficiency as the R_{ds} path consumes minimum power from the AC power source. During the descent portion of the applied AC voltage, the switch transistors are activated in the order reversely.

The controlled LED current is completely determined by fixed-value components values. For example, with R₁ₛ=1 [Ω], R₁=100 [Ω], V_{L}=17 [V], an R₂ value of 150 [Ω] will control the LED current I_{L} near 12 [mA]. Table 1 illustrates a set of values for a string of nine (m=9) LED sections.

TABLE 1

| Section | Designed control current | R₂ value in [kΩ], |
|---|---|---|
| number | in [mA] | R₁ = 100 [Ω], Rₛ = 1 [Ω] |
| 1 | 12 | 150 |
| 2 | 24 | 68 |
| 3 | 36 | 47 |
| 4 | 48 | 36 |
| 5 | 60 | 29.4 |
| 6 | 72 | 24 |
| 7 | 84 | 20 |
| 8 | 96 | 18 |
| 9 | 108 | 16 |

FIG. 4 illustrates voltage-current characteristics for two types of LEDs. LED1 has a steep slope indicating that the LED current will increase rapidly when the LED voltage reaches a certain voltage level. LED2, typically associated with a larger internal LED resistance than LED1, has a slower slope indicating that the LED current will not increase as fast. This current sensing feedback approach works well with both types of LEDs because the feedback is established by measuring the LED current directly such that the change of the current is detected and a control signal is generated with a short delay.

Because of the steep slope in the LED's voltage-current characteristic and some delay in the feedback path provided by the amplifier L₁, current spikes may be observed just before the current is controlled to the desired plateau. A remedy to limit these current spikes involves the placement of a small capacitor C. The capacitor C acts as an additional feedback path from the LED: as the current through the LED rises rapidly, the cathode voltage will drop compared to the anode and the source of T₁. This rapid voltage drop is supplied to the gate of T₁ as the voltage over C cannot be discontinuous. A subsequent slow charge of C through R_{gs} should then be long enough to temporarily pinch off T₁ before the active feedback path is established. A capacitance C of around 100 [pF] is usually sufficient. In some alternative embodiments, the bottom electrode of C may be connected directly to the cathode of the LED device.

Referring back to FIG. 2, the ladder network has dimming capability with dimmer circuit 220, which provides for activation of only a selected number of light sections of the ladder. This selected number can include only the first section (LS₁), all sections (LS₁ to LSₘ), or a selection from the first section (LS₁) to a section LSₙ where n<m. The dimmer circuit is configured to control the number of the light sections activated in sequence. The intensity (dimming) is controlled based upon how many light sections are active with the LEDs turned on with a particular intensity selected by the dimmer circuit.

The ladder network also enables color control through use of dimmer circuit 220. The color output collectively by the LEDs is determined by the dimmer controlling which light sections are active, the selected sequence of light sections, and the arrangement of LEDs in the light sections from the first light section to the last light section. As the light sections turn on in sequence, the arrangement of the LEDs determines the output color with colors 1, 2, . . . m correlated to the color of the LEDs in light sections LS₁, LS₂, . . . LSₘ. The output color is also based upon color mixing among active LEDs in the selected sequence of light sections in the ladder.

The circuitry leads to outstanding power factor performance. FIG. 5 is a graph illustrating power factor performance of the current-sensing LED ladder driver in FIG. 3. The power factor PF is evaluated using the general formula for line voltage V and current I shown in equation (3), with T covering an exact integer number of periods and τ arbitrary:

$$PF = \frac{{\int }_{τ}^{τ + T} V \times I d t}{{TV}_{rms} {I}_{rms}} \qquad ( 3 )$$

With the circuitry of the ladder network, power factors of 0.98 or better are easily obtained. For example, the PF value in FIG. 5 is 0.993.

It is also possible to define a single quantity of current total harmonic distortion (THD) to evaluate harmonic performance. Equation (4) defines a THD with the property of 0<THD<1. With I indicating current amplitude and its subscript the harmonic order of the fundamental 60 [Hz] component, the following THD quantity is defined as:

$$\begin{matrix}T H D = \frac{\sqrt{{I}_{2}^{2} + {I}_{3}^{2} + {I}_{4}^{2} + …}}{\sqrt{{I}_{1}^{2} + {I}_{2}^{2} + {I}_{3}^{2} + {I}_{4}^{2} + …}} \\ = \frac{\sqrt{{\sum }_{n = 2}^{∞} {I}_{n}^{2}}}{\sqrt{{\sum }_{n = 1}^{∞} {I}_{n}^{2}}}\end{matrix} \qquad ( 4 )$$

Table 2 illustrates International Electrotechnical Commission (IEC) compliance mandated in Europe since 2001.

TABLE 2

| | IEC maximum allowed amplitude |
|---|---|
| | normalized on fundamental for class C |
| harmonic | lighting equipment |
| 2^{nd} | 0.02 |
| 3^{rd} | 0.3 × PF |
| 5^{th} | 0.1 |
| 7^{th} | 0.07 |
| 9^{th} | 0.05 |
| 9 < order < 40 | 0.03 |

In general, when THD<0.1, Table 2 compliance is obtained and the THD can be a meaningful guide for current harmonic performance. For a perfectly harmonic voltage, it can be shown that PF in equation (3) and THD in equation (4) are related by:

$$T H D = \sqrt{1 - \frac{{PF}^{2}}{{cos}^{2} {ϕ}_{1}}} \qquad ( 5 )$$

where φ₁ is the phase angle between voltage and fundamental current component.

FIG. 6 is a graph illustrating a current spectrum of a current-sensing LED ladder driver having harmonic distortion within the IEC Limits. The spectrum in FIG. 6 is computed based upon the discrete samples of exactly one period of the LED current waveform in FIG. 5. The spectrum is generated by adding j times the Hilbert transform of the waveform with j²=−1. This is spectrally equivalent to filtering out all negative frequency components and multiplying the positive frequency components by 2. With such computation, the spectral amplitude in FIG. 6 is easily reconciled with the current amplitude in FIG. 5. The THD value of the spectrum in FIG. 6 is 9.8%.

The components of circuits 200 and 300, with or without the LEDs, can be implemented in an integrated circuit. For separate LEDs, leads connecting the LEDs enable the use as a driver in solid state lighting devices. Examples of solid state lighting devices are described in U.S. patent application Ser. No. 12/535,203 and filed on Aug. 4, 2009, U.S. patent application Ser. No. 12/960,642 and filed on Dec. 6, 2010, and U.S. patent application Ser. No. 13/019,498 and filed on Feb. 2, 2011, all of which are incorporated herein by reference as if fully set forth.

What is claimed is:

1. A circuit for controlling operation of light emitting diodes (LEDs), comprising:
a plurality of light sections connected in series, the light sections being configured for connection to an AC power source, wherein each light section comprises:
an LED having an LED current flowing through the LED;
a switch coupled to the LED; and
a current sensing feedback circuit coupled to the switch and the LED,
wherein the current sensing feedback circuit is configured to generate a sensing signal indicative of the LED current, generate a feedback signal based upon the sensing signal, and provide the feedback signal to the switch,
wherein the switch activates the LED and controls the LED current based upon the feedback signal,
wherein at least two light sections are activated in sequence in response to power supplied from the AC power source.

2. The circuit of claim 1, wherein the switch comprises a transistor.

3. The circuit of claim 2, wherein the switch comprises a depletion FET.

4. The circuit of claim 1, wherein each light section includes a plurality of LEDs connected in series, the plurality of LEDs coupled to the switch and the current sensing feedback circuit of the corresponding light section.

5. The circuit of claim 1, wherein the current sensing feedback circuit comprises at least one of an enhancement FET, a bipolar transistor, an amplifier, and a comparator.

6. The circuit of claim 1, wherein the current control feedback circuit comprises a resistive element connected to the LED in series, the resistive element is capable of providing a voltage signal based upon the LED current.

7. The circuit of claim 1, further comprising a capacitor coupled to the LED and the switch.

8. The circuit of claim 1, further comprising a rectifier coupled between the light sections and the AC power source.

9. The circuit of claim 8, further comprising a dimmer circuit coupled to the rectifier, the dimmer circuit is configured to control the number of the light sections activated in sequence.

10. The circuit of claim 9, wherein the dimmer circuit comprises a TRIAC.

11. The circuit of claim 9, wherein the dimmer circuit comprises phase cutting electronics.

12. A circuit for controlling operation of light emitting diodes (LEDs), comprising:
a plurality of light sections connected in series, the light sections being configured for connection to a power source, wherein each light section comprises:
an LED device comprising at least one LED junction, wherein an LED current flows through the LED device;
a current sensing element coupled to the LED device, the current sensing element configured to generate a signal indicative of the LED current;
an amplification circuit having fixed value components coupled to the current sensing element, the amplification circuit configured to receive the signal indicative of the LED current and output a signal based upon the received signal; and
a switch coupled to the amplification circuit and the LED device,
wherein the switch activates the LED device and controls the LED current based upon the output signal of the amplification circuit,
wherein at least two light sections are activated in sequence in response to power output from the power source.

13. The circuit of claim 12, wherein the switch comprises a transistor.

14. The circuit of claim 13, wherein the switch comprises a depletion FET.

15. The circuit of claim 12, wherein the LED device comprises a plurality of LED junctions.

16. The circuit of claim 12, wherein the amplification circuit comprises an amplifier operable with low supply current.

17. The circuit of claim 12, wherein the current sensing element comprises a resistive element.

18. The circuit of claim 12, further comprising a rectifier coupled between the light sections and the power source.

19. The circuit of claim 12, further comprising a dimmer circuit coupled to the rectifier, the dimmer circuit is configured to control the number of the light sections activated in sequence.
